(19) United States
(12) Patent Application Publication
(10) Pub. No.: US 2020/0112943 A1
(43) Pub. Date: Apr. 9, 2020

(54) CONTROL CHANNEL DESIGN FOR WIDEBAND COVERAGE ENHANCEMENT (WCE) SYSTEM INFORMATION BLOCK (SIB) TRANSMISSION

(71) Applicant: Intel IP Corporation, Santa Clara, CA (US)

(72) Inventors: Wenting Chang, Beijing (CN); Salvatore Talarico, Sunnyvale, CA (US); Huaning Niu, San Jose, CA (US); Yuan Zhu, Beijing (CN); Qiaoyang Ye, San Jose, CA (US)

(21) Appl. No.: 16/462,192

(22) PCT Filed: Jun. 28, 2018
(86) PCT No.: PCT/US2018/040110

§ 371 Date: May 17, 2019

Related U.S. Application Data
(60) Provisional application No. 62/526,864, filed on Jun. 29, 2017.
(60) Provisional application No. 62/547,634, filed on Aug. 18, 2017.

(51) Int. Cl. H04W 72/04; H04L 5/00

(52) U.S. Cl. CPC H04W 72/042; H04W 4/70; H04L 5/0007; H04L 5/0053

(57) ABSTRACT

Technology for a next generation node B (gNB) operable for wideband coverage enhancement (WCE) communication in a MulteFire cell is disclosed. The gNB can determine, at the gNB, an aggregation level (AL) for an enhanced physical downlink control channel (ePDCCH). The gNB can determine, at the gNB, an ePDCCH transmission type indicator in a master information block (MIB). The gNB can allocate, based on the ePDCCH transmission type indicator in the MIB, resource blocks for the ePDCCH. The gNB can encode, at the gNB, control information in an ePDCCH for a system information block MulteFire (SIB-MF) transmission in a first subframe of a discovery reference signal (DRS).

### BACKGROUND

Wireless systems typically include multiple User Equipment (UE) devices communicatively coupled to one or more Base Stations (BS). The one or more BSs may be Long Term Evolved (LTE) evolved NodeBs (eNB) or new radio (NR) NodeBs (gNB) or next generation node Bs (gNB) that can be communicatively coupled to one or more UEs by a Third-Generation Partnership Project (3GPP) network.

Next generation wireless communication systems are expected to be a unified network/system that is targeted to meet vastly different and sometimes conflicting performance dimensions and services. New Radio Access Technology (RAT) is expected to support a broad range of use cases including Enhanced Mobile Broadband (eMBB), Massive Machine Type Communication (mMTC), Mission Critical Machine Type Communication (uMTC), and similar service types operating in frequency ranges up to 100 GHz.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a block diagram of an orthogonal frequency division multiple access (OFDMA) frame structure in accordance with an example;

FIG. 2 depicts functionality of a radio resource control (RRC) configured enhanced physical downlink control channel (ePDCCH) in accordance with an example;

FIG. 3 illustrates resource block allocation for the enhanced physical downlink control channel (ePDCCH) in accordance with an example;

FIG. 4 illustrates resource block allocation for the enhanced physical downlink control channel (ePDCCH) in accordance with an example;

FIG. 5 illustrates resource block allocation for the enhanced physical downlink control channel (ePDCCH) in accordance with an example;

FIG. 6 depicts functionality of a next generation node B (gNB) operable for wideband coverage enhancement (WCE) communication in a MulteFire cell in accordance with an example;

FIG. 7 depicts functionality of a user equipment (UE) operable for wideband coverage enhancement (WCE) communication in a MulteFire cell in accordance with an example;

FIG. 8 depicts a flowchart of a machine readable storage medium having instructions embodied thereon for performing wideband coverage enhancement (WCE) communication in a MulteFire cell in accordance with an example;

FIG. 9 illustrates an architecture of a wireless network in accordance with an example;

FIG. 10 illustrates a diagram of a wireless device (e.g., UE) in accordance with an example;

FIG. 11 illustrates interfaces of baseband circuitry in accordance with an example; and

FIG. 12 illustrates a diagram of a wireless device (e.g., UE) in accordance with an example.

Reference will now be made to the exemplary embodiments illustrated, and specific language will be used herein to describe the same. It will nevertheless be understood that no limitation of the scope of the technology is thereby intended.

### DETAILED DESCRIPTION

Before the present technology is disclosed and described, it is to be understood that this technology is not limited to the particular structures, process actions, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating actions and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Both 3GPP LTE Release 13 Enhanced Machine-Type Communication (eMTC) and 3GPP LTE Release 13 NarrowBand Internet of Things (NB-IoT) operate in the licensed spectrum. However, the scarcity of licensed spectrum in the low frequency band can result in a deficit in the data boost rate. Therefore, there is an emerging interest in the operation of LTE systems in unlicensed spectrum.

Potential LTE operations in unlicensed spectrum can include, but is not limited to, Carrier Aggregation based licensed assisted access (LAA) and enhanced LAA (eLAA) systems, LTE operation in the unlicensed spectrum via dual connectivity (DC), and the standalone LTE system in the unlicensed spectrum in which LTE-based technology solely operates in unlicensed spectrum without using an anchor in the licensed spectrum, which is also known as MulteFire.

Internet of Things (IoT) is envisioned as a significant technology component, which can have lots of potential to change our daily life by enabling connectivity between a multitude of devices. IoT can have widespread applications in various scenarios, such as smart cities, smart environment, smart agriculture, and smart health systems.

3GPP has standardized two designs to support IoT services—eMTC and NB-IoT. Because eMTC user equipments (UEs) and NB-IoT UEs will be deployed in large numbers, it can be important to lower the cost of these UEs in order to enable the implementation of IoT. Additionally, low power consumption is desirable to extend the lifetime of the battery of the UEs.

Moreover, devices can be deployed deep inside buildings. These devices that are deployed deep inside buildings can benefit from coverage enhancement (CE) in comparison with the defined LTE cell coverage footprint.

To summarize, eMTC and NB-IoT techniques can be designed to ensure that UEs have low cost, low power consumption, and enhanced coverage. In order to extend the benefits of LTE IoT designs into unlicensed spectrum, MulteFire 1.1 can specify the design for Unlicensed IoT (U-IoT) based on eMTC and/or NB-IoT. The unlicensed frequency band of interest for NB-IoT or eMTC based U-IoT can be the sub-1 gigahertz (GHz) band and the 2.4 GHz band.

In addition to these use cases for eMTC and NB-IoT, which both apply to narrowband operation, wideband coverage enhancement (WCE) can also be deployed in MulteFire 1.1 with operation bandwidth of 10 megahertz (MHz) and 20 MHz. One of the objectives of WCE can be to extend MulteFire 1.0 coverage to meet IoT market demand, with target operating bands at 3.5 GHz and 5.0 GHz.

In one example, for physical downlink control channel (PDCCH) downlink control information (DCI) format 1C, the distributed virtual resource blocks (VRBs) can be assigned. Distributed VRB allocation for a UE can range, in steps of 4 RBs, up to 96 VRBs. For PDCCH DCI format 1A, localized VRBs or distributed VRBs can be supported, ranging from 1 VRB to 96 VRBs with an N_{gap,1} e.g., 48 for a 20 MHz system, and an N_{gap,2} e.g., 16 for a 20 MHz system, where N_{gap,1} and N_{gap,2} are gap values used in PDCCH DCI format 1A.

In another example, two discovery reference signal (DRS) subframes can be transmitted within one occasion. For a legacy UE, the legacy UE can detect the legacy PDCCH and the corresponding physical downlink shared channel (PDSCH) in order to detect the essential system information, located in the system information block MulteFire (SIB-MF). The SIB-MF can contain system information about system information block 1 (SIB1) and system information block 2 (SIB2). For a wideband coverage enhancement (WCE) UE, the WCE UE can detect the ePDCCH to derive parameters for WCE SIB-MF demodulation. However, the ePDCCH parameters may not depend on the UE type.

There are various ways in which the ePDCCH can be configured. Herein, configuration can be achieved by using the MIB to configure the ePDCCH for SIB-MF transmission.

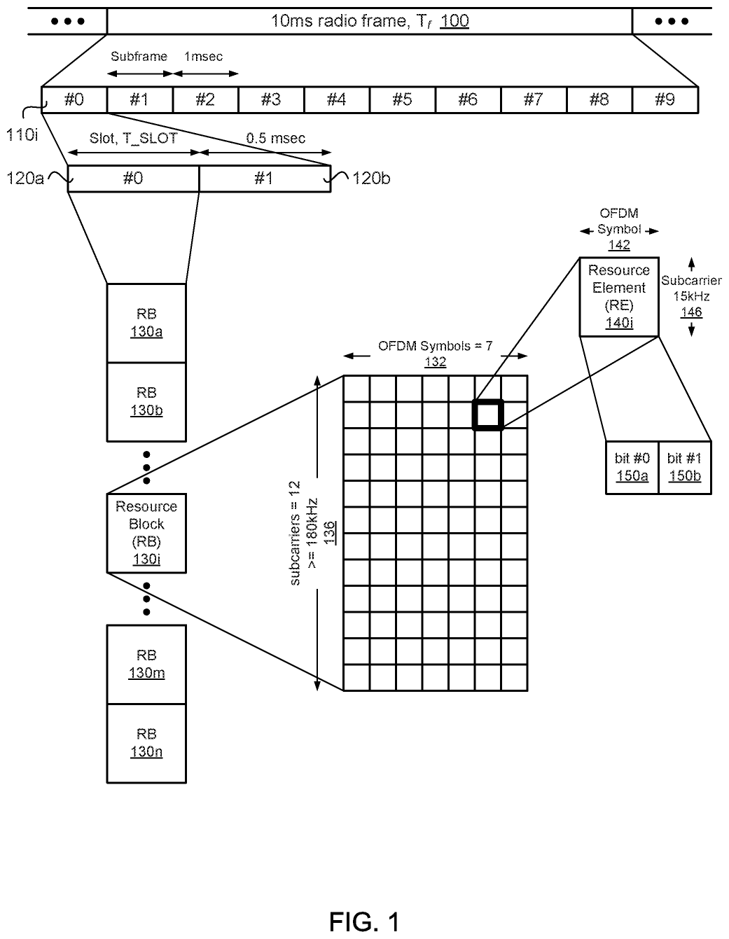

FIG. 1 provides an example of a 3GPP LTE Release 8 frame structure. In particular, FIG. 1 illustrates a downlink radio frame structure type 2. In the example, a radio frame 100 of a signal used to transmit the data can be configured to have a duration, T_{f}, of 10 milliseconds (ms). Each radio frame can be segmented or divided into ten subframes 110i that are each 1 ms long. Each subframe can be further subdivided into two slots 120a and 120b, each with a duration, Tₛₗₒₜ, of 0.5 ms. The first slot (#0) 120a can include a legacy physical downlink control channel (PDCCH) 160 and/or a physical downlink shared channel (PDSCH) 166, and the second slot (#1) 120b can include data transmitted using the PDSCH.

Each slot for a component carrier (CC) used by the node and the wireless device can include multiple resource blocks (RBs) 130a, 130b, 130i, 130m, and 130n based on the CC frequency bandwidth. The CC can have a carrier frequency having a bandwidth and center frequency. Each subframe of the CC can include downlink control information (DCI) found in the legacy PDCCH. The legacy PDCCH in the control region can include one to three columns of the first Orthogonal Frequency Division Multiplexing (OFDM) symbols in each subframe or RB, when a legacy PDCCH is used. The remaining 11 to 13 OFDM symbols (or 14 OFDM symbols, when legacy PDCCH is not used) in the subframe may be allocated to the PDSCH for data (for short or normal cyclic prefix).

The control region can include physical control format indicator channel (PCFICH), physical hybrid automatic repeat request (hybrid-ARQ) indicator channel (PHICH), and the PDCCH. The control region has a flexible control design to avoid unnecessary overhead. The number of OFDM symbols in the control region used for the PDCCH can be determined by the control channel format indicator (CFI) transmitted in the physical control format indicator channel (PCFICH). The PCFICH can be located in the first OFDM symbol of each subframe. The PCFICH and PHICH can have priority over the PDCCH, so the PCFICH and PHICH are scheduled prior to the PDCCH.

Each RB (physical RB or PRB) 130i can include 12-15 kilohertz (kHz) subcarriers 136 (on the frequency axis) and 6 or 7 orthogonal frequency-division multiplexing (OFDM) symbols 132 (on the time axis) per slot. The RB can use seven OFDM symbols if a short or normal cyclic prefix is employed. The RB can use six OFDM symbols if an extended cyclic prefix is used. The resource block can be mapped to 84 resource elements (REs) 140i using short or normal cyclic prefixing, or the resource block can be mapped to 72 REs (not shown) using extended cyclic prefixing. The RE can be a unit of one OFDM symbol 142 by one subcarrier (i.e., 15 kHz) 146.

Each RE can transmit two bits 150a and 150b of information in the case of quadrature phase-shift keying (QPSK) modulation. Other types of modulation may be used, such as 16 quadrature amplitude modulation (QAM) or 64 QAM to transmit a greater number of bits in each RE, or bi-phase shift keying (BPSK) modulation to transmit a lesser number of bits (a single bit) in each RE. The RB can be configured for a downlink transmission from the eNodeB to the UE, or the RB can be configured for an uplink transmission from the UE to the eNodeB.

This example of the 3GPP LTE Release 8 frame structure provides examples of the way in which data is transmitted, or the transmission mode. The example is not intended to be limiting. Many of the Release 8 features will evolve and change in 5G frame structures included in 3GPP LTE Release 15, MulteFire Release 1.1, and beyond. In such a system, the design constraint can be on co-existence with multiple 5G numerologies in the same carrier due to the coexistence of different network services, such as eMBB (enhanced Mobile Broadband) 204, mMTC (massive Machine Type Communications or massive IoT) 202 and URLLC (Ultra Reliable Low Latency Communications or Critical Communications) 206. The carrier in a 5G system can be above or below 6 GHz. In one embodiment, each network service can have a different numerology.

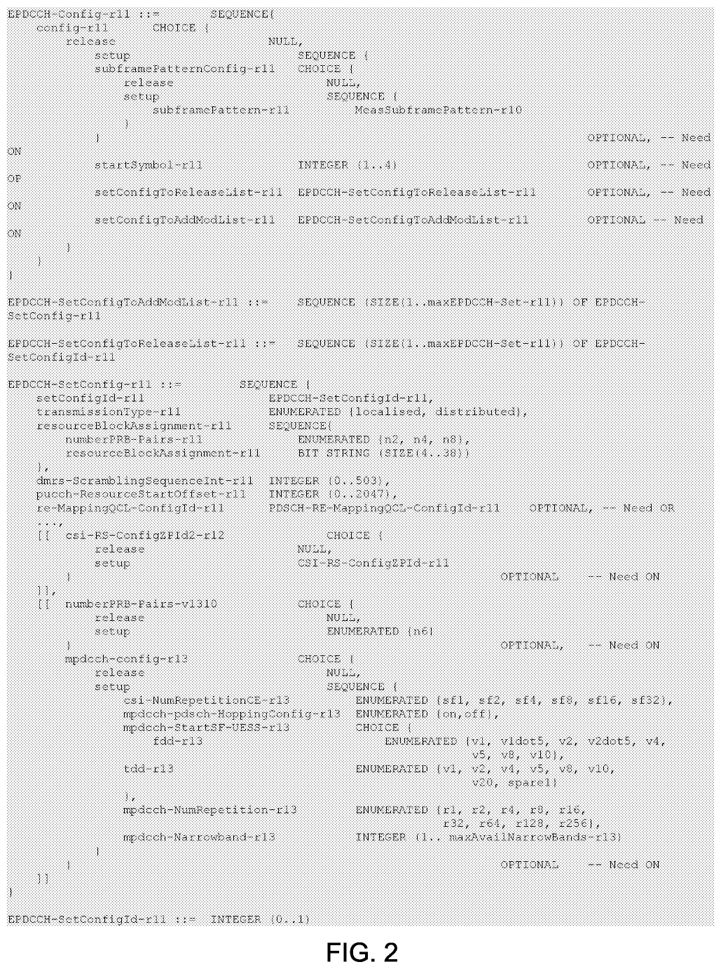

In another example, as depicted in FIG. 2, the radio resource control (RRC) configured enhanced physical downlink control channel (ePDCCH) can be indicated. Because of the limitation of master information block (MIB) capacity, which can have only 7 reserved bits, 7 reserved bits can be utilized for ePDCCH parameter configuration.

In another example, the MeasSubframePattern of the ePDCCH may not be used. In this example, the subframe that contains the ePDCCH for SIB-MF can be pre-defined in accordance with the following options. In a first option, the ePDCCH for SIB-MF transmission can exist in the first subframe within one discovery reference signal (DRS) occasion. Two DRS subframes can be transmitted within one DRS occasion. Therefore, in this example, the ePDCCH for SIB-MF transmission can exist in the first subframe within one DRS occasion but may not exist in the second subframe within one DRS occasion. In a second option, the ePDCCH for SIB-MF transmission can exist in every subframe within one DRS occasion, i.e. the ePDCCH for SIB-MF transmission can exist in the first and the second subframe of the DRS occasion. In another example, a gNB can encode control information in an ePDCCH for a SIB-MF transmission in a first subframe of a DRS occasion.

In another example, the starting OFDM symbol for the first subframe within one DRS occasion can be fixed to be OFDM symbol #2, and the starting OFDM symbol for the second, or remaining subframe, can be fixed to be OFDM symbol #0.

In another example, the ePDCCH can have various transmission types. In a first option, the transmission type for the ePDCCH can be a localized mode. This first option can provide for simplicity in the transmission of the ePDCCH. In a second option, the transmission type for the ePDCCH can be a distributed mode. This second option can provide for better performance in the transmission of the ePDCCH. In a third option, the transmission type can be indicated by one bit in the MIB. The transmission type indicator in the MIB can allocate resource blocks for the ePDCCH. Based on the ePDCCH transmission type in the MIB, resource blocks for the ePDCCH can be allocated, wherein the resource blocks for the ePDCCH are contiguous or distributed.

In another example, the number of resource blocks for ePDCCH transmission, N_{RB,ePDCCH}, can be fixed to 8 resource blocks or 16 resource blocks. Fixing the number of resource blocks to 8 resource blocks can achieve an aggregation level (AL) of 32. Fixing the number of resource blocks to 16 resource blocks can achieve an aggregation level (AL) of 64.

In the legacy system, for 100 resource blocks, scheduling 8 resource blocks can cost up to 38 bits. Moreover, it can cost more bits to schedule 16 resource blocks. A cost of 38 bits or more can be beyond the capacity of the MIB, which can have only 7 reserved bits for utilized for ePDCCH parameter configuration.

In another example, the resource block allocation for the ePDCCH can be allocated based on the physical resource block (PRB) assignment or the virtual resource block (VRB) assignment. When allocating resource blocks for the ePDCCH based on the PRB assignment, contiguous resource blocks can be reserved for resource allocation type 2 which can be utilized by downlink control information (DCI) format 1A and DCI format 1C for the physical downlink shared channel (PDSCH). Resource allocation type 2 can be a type of RB allocation for PDSCH.

In another example, in a first option, 16 contiguous resource blocks can start from either the minimum PRB index, e.g. PRB #0, or the maximum PRB index, e.g. PRB #99 for a 20 MHz system. The offset between different candidates can be denoted by N_{RB,offset} e.g., 16. The indicator in the MIB can be denoted as n. In this example, the ePDCCH can occupy the PRBs ranging from [n*N_{RB,offset}] to [(n*N_{RB,offset})+N_{RB,ePDCCH}−1] if the first candidate starts from 0.

In another example, in the alternative, the ePDCCH can occupy the PRBs ranging from [N_{RB}^{DL}−1−[(n*N_{RB,offset})] to [N_{RB}^{DL}−N_{RB,ePDCCH}−(n*N_{RB,offset})], in which the association between the ePDCCH resource block index and the PRB index can be based on either decreasing or increasing order.

In another example, if the number of resource blocks for ePDCCH transmission, N_{RB,ePDCCH}, is equal to 16, if the offset between different ePDCCH candidates, N_{RB,offset}, is also equal to 16, and if the allocation starts from the minimum PRB index, then a maximum of 6 candidates can be supported. In this example: the first candidate can range from a PRB index of #0 to a PRB index of #15, the second candidate can range from a PRB index of #16 to a PRB index of #31, the third candidate can range from a PRB index of #32 to a PRB index of #47, the fourth candidate can range from a PRB index of #48 to a PRB index of #63, the fifth candidate can range from a PRB index of #64 to a PRB index of #79, and the sixth candidate can range from a PRB index of #80 to a PRB index of #95. In this example, three bits in the MIB can be sufficient to configure the ePDCCH i.e. n can be 0, 1, 2, 3, 4, or 5.

In another example, if the number of resource blocks for ePDCCH transmission, N_{RB,ePDCCH}, is equal to 16, if the offset between different ePDCCH candidates, N_{RB,offset}, is also equal to 16, and if the allocation starts from the maximum PRB index, then a maximum of 6 candidates can be supported. In this example: the first candidate can range from a PRB index of #99 to a PRB index of #84, the second candidate can range from a PRB index of #83 to a PRB index of #68, the third candidate can range from a PRB index of #67 to a PRB index of #52, the fourth candidate can range from a PRB index of #51 to a PRB index of #36, the fifth candidate can range from a PRB index of #35 to a PRB index of #20, and the sixth candidate can range from a PRB index of #19 to a PRB index of #4. In this example, three bits in the MIB can be sufficient to configure the ePDCCH i.e. n can be 0, 1, 2, 3, 4, or 5.

In another example, in a second option, the resource block allocation for the ePDCCH can be allocated based on multiple contiguous subsets of resource blocks. In this example, for two subsets of resource blocks, each subset can contain 8 resource blocks. In this example, one subset can start from the minimum PRB index, e.g. PRB #0 to PRB #7, and the other subset can range from the maximum PRB index in decreasing order, e.g. PRB #99 to PRB #92 in the case of a 20 MHz system. This allocation of resource blocks can achieve frequency diversity.

In another example, N_{RB,offset} can denote the offset for each subset between different candidates, e.g., 8 resource blocks. In this example, n can denote the indicator in the MIB. In this example, one ePDCCH subset can occupy the PRBs ranging from

$$[ n * {N}_{RB , offset} ] to [ ( n * {N}_{RB , offset} ) + \frac{{N}_{RB , ePDCCH}}{2} - 1 ] ,$$

and the other subset can occupy the PRBs ranging from

$$[ {N}_{RB}^{DL} - 1 - [ ( n * {N}_{RB , offset} ) ] to [ {N}_{RB}^{DL} - \frac{{N}_{RB , ePDCCH}}{2} - ( n * {N}_{RB , offset} ) ] .$$

In another example, if the number of resource blocks for ePDCCH transmission, N_{RB,ePDCCH}, is equal to 16, if the offset for each subset between different ePDCCH candidates, N_{RB,offset}, is equal to 8, and if the allocation starts from the minimum PRB index for one subset, e.g. subset A, and the maximum PRB index for the other subset, e.g. subset B, then a maximum of 6 candidates can be supported. In this example: the first candidate of subset A can range from a PRB index of #0 to a PRB index of #7, the second candidate of subset A can range from a PRB index of #8 to a PRB index of #15, the third candidate of subset A can range from a PRB index of #16 to a PRB index of #23, the fourth candidate of subset A can range from a PRB index of #24 to a PRB index of #31, the fifth candidate of subset A can range from a PRB index of #32 to a PRB index of #39, and the sixth candidate of subset A can range from a PRB index of #40 to a PRB index of #47.

In this example: the first candidate of subset B can range from a PRB index of #99 to a PRB index of #92, the second candidate of subset B can range from a PRB index of #91 to a PRB index of #84, the third candidate of subset B can range from a PRB index of #83 to a PRB index of #76, the fourth candidate of subset B can range from a PRB index of #75 to a PRB index of #68, the fifth candidate of subset B can range from a PRB index of #67 to a PRB index of #60, and the sixth candidate of subset B can range from a PRB index of #59 to a PRB index of #52. In this example, three bits in the MIB can be sufficient to configure the ePDCCH i.e. n can be 0, 1, 2, 3, 4, or 5.

In another example, for either option 1 or option 2, the offset can be defined in terms of either PRB indices or PRB subsets, e.g. 16 resource blocks or 8 resource blocks. In another example, candidates for the ePDCCH can be configured in an interleaved way, e.g. candidate 0 can start from the minimum PRB index with an increasing order of PRBs and candidate 1 can start from the maximum PRB index with a decreasing order of PRBs.

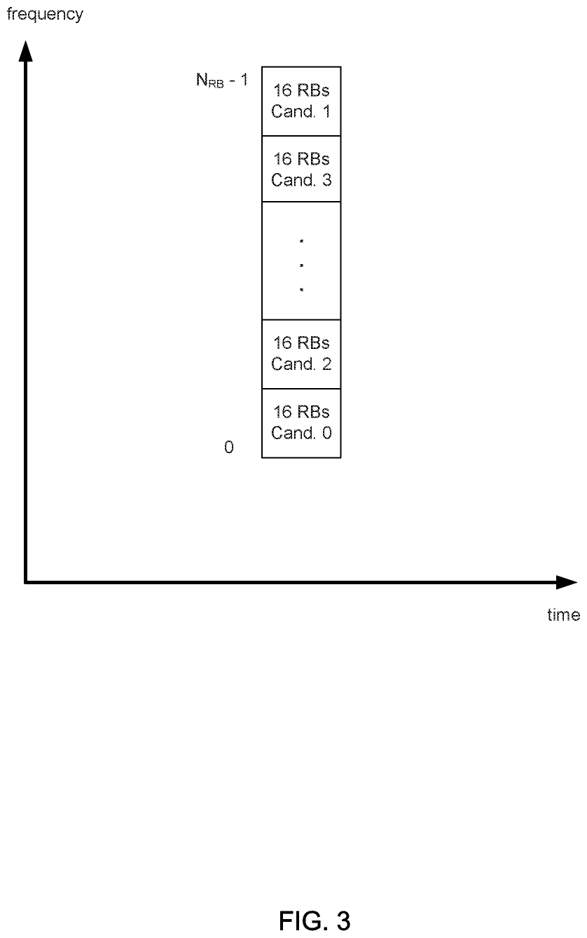

In another example, as illustrated in FIG. 3, Candidate 0 can occupy the PRB indices ranging from 0 to 15, Candidate 1 can occupy the PRB indices ranging from 99 to 84, Candidate 2 can occupy the PRB indices ranging from 16 to 31, Candidate 3 can occupy the PRB indices ranging from 83 to 68, and so forth. In this example, the N_{RB,ePDCCH} can be equal to 16 and the N_{RB,offset} can be equal to 16.

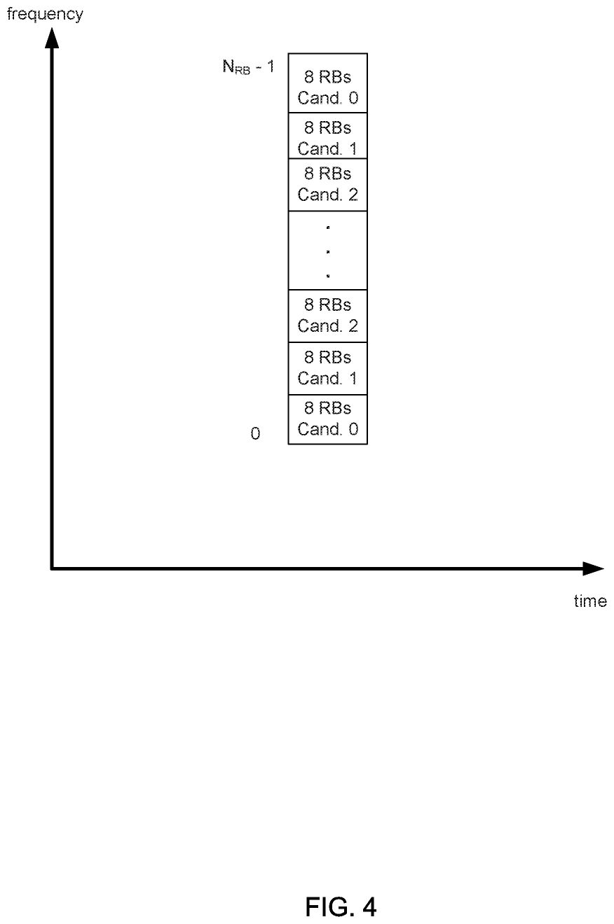

In another example, as illustrated in FIG. 4, Candidate 0 of one subset can occupy the PRB indices ranging from 0 to 7 and Candidate 0 of the other subset can occupy the PRB indices ranging from 99 to 92; Candidate 1 of one subset can occupy the PRB indices ranging from 8 to 15 and Candidate 1 of the other subset can occupy the PRB indices ranging from 91 to 84; Candidate 2 of one subset can occupy the PRB indices ranging from 16 to 23, and Candidate 2 of the other subset can occupy the PRB indices ranging from 83 to 76; and so forth. In this example, the N_{RB,ePDCCH} can be equal to 16 and the N_{RB,offset} can be equal to 8.

In another example, if the resource blocks for the WCE ePDCCH collide with the PRBs that have been assigned for the legacy PDSCH transmission, then the resource blocks for the WCE ePDCCH can be punctured.

In another example, the resource block allocation for the ePDCCH can be allocated based on the virtual resource block (VRB) assignment. In one example, the VRBs can be contiguous VRBs. The contiguous VRBs can start from either the minimum PRB index e.g., VRB #0, or the maximum PRB index e.g, VRB #95 for a 20 MHz system. N_{VRB}^{DL} can denote the total number of virtual resource blocks i.e. 96; N_{RB,offset}, i.e. 16, can denote the resource block offset between adjacent candidates; and n can denote the indicator in the MIB. In this example, the ePDCCH can occupy the VRBs ranging from [n*N_{RB,offset}] to [(n*N_{RB,offset})+(N_{RB,ePDCCH}−1)] if the first candidate starts from 0. In this example, a maximum of 6 candidates can be supported, wherein n is equal to 0, 1, 2, 3, 4, or 5; therefore 3 bits in the MIB can be sufficient to configure the ePDCCH. In this example, with N_{RB,offset} equal to 16 and N_{RB,ePDCCH} equal to 16, candidate 0 can occupy the VRBs ranging from VRB #0 to VRB #15; candidate 1 can occupy the VRBs ranging from VRB #16 to VRB #31; candidate 2 can occupy the VRBs ranging from VRB #32 to VRB #47; candidate 3 can occupy the VRBs ranging from VRB #48 to VRB #63; candidate 4 can occupy the VRBs ranging from VRB #64 to VRB #79; and candidate 5 can occupy the VRBs ranging from VRB #80 to VRB #95.

In another example, the ePDCCH can occupy the VRBs ranging from to [N_{VRB}^{DL}−1−(n*N_{RB,offset})] to [N_{VRB}^{DL}−N_{RB,ePDCCH}−(n*N_{RB,offset})], where the association between the ePDCCH PRB index and the VRB index can be based on either decreasing or increasing order. In this example, with N_{RB,offset} equal to 16 and N_{RB,ePDCCH} equal to 16, candidate 0 can occupy the VRBs ranging from VRB #95 to VRB #80; candidate 1 can occupy the VRBs ranging from VRB #79 to VRB #64; candidate 2 can occupy the VRBs ranging from VRB #63 to VRB #48; candidate 3 can occupy the VRBs ranging from VRB #47 to VRB #32; candidate 4 can occupy the VRBs ranging from VRB #31 to VRB #16; and candidate 5 can occupy the VRBs ranging from VRB #15 to VRB #0.

In another example, more than one candidate can be defined, where the offset between adjacent candidates can be defined the unit of one VRB or one VRB set, e.g. 8 VRBs or 16 VRBs.

In another example, the resource allocation of the ePDCCH can be derived based on localized resource blocks or virtualized resource blocks, and the resource allocation can be configured by the MIB using one bit. In another example, for the resource blocks for the ePDCCH, a first set of the resource blocks can be virtual distributed resource blocks and a second set of the resource blocks can be virtual distributed resource blocks or remaining contiguous resource blocks. The first set of resource blocks for the ePDCCH can comprise 8 virtual distributed resource blocks. The second set of the resource blocks for the ePDCCH can comprise 4 virtual distributed resource blocks and 4 remaining contiguous resource blocks.

In another example, the resource blocks for the ePDCCH can comprise 16 contiguous resource blocks starting from a maximum PRB index value.

In another example, the demodulation reference signal (DM-RS) for ePDCCH can use the same scrambling sequence as the scrambling sequence for the first DRS subframe e.g., 0, when the first DRS locates within subframes 0 to 4, and e.g., 5, when the first DRS locates within subframes 5 to 9.

In another example, a maximum of 4 bits can be utilized by the MIB to configure the ePDCCH in order to create a tradeoff between flexibility and overhead.

In a first option, 4 bits in total can be utilized by the MIB. In this option, 1 bit can be used for the RB assignment type and 3 bits can be used for the resource indicator.

In a second option, 3 bits in total can be utilized by the MIB. In this option, 1 bit can be used for the RB assignment type and 2 bits can be used for the resource indicator, which can support a maximum of 4 candidates. Alternatively, the RB assignment type can be predefined and a maximum of 8 candidates can be supported.

In a third option, 2 bits in total can be utilized by the MIB. In this option, 1 bit can be used for the RB assignment type and 1 bit can be used for the resource indicator, which can support a maximum of 2 candidates. Alternatively, the RB assignment type can be predefined and a maximum of 4 candidates can be supported.

In a fourth option, 1 bit in total can be utilized by the MIB. In this option, 1 bit can be used for the RB assignment type. Alternatively, the RB assignment type can be predefined and a maximum of 2 candidates can be supported.

In another example, the resource blocks for SIB-MF can contain the remaining contiguous PRBS, i.e. the PRBs that are not assigned as VRBs (PRB #96 to PRB #99), as well as the distributed virtual PRBs.

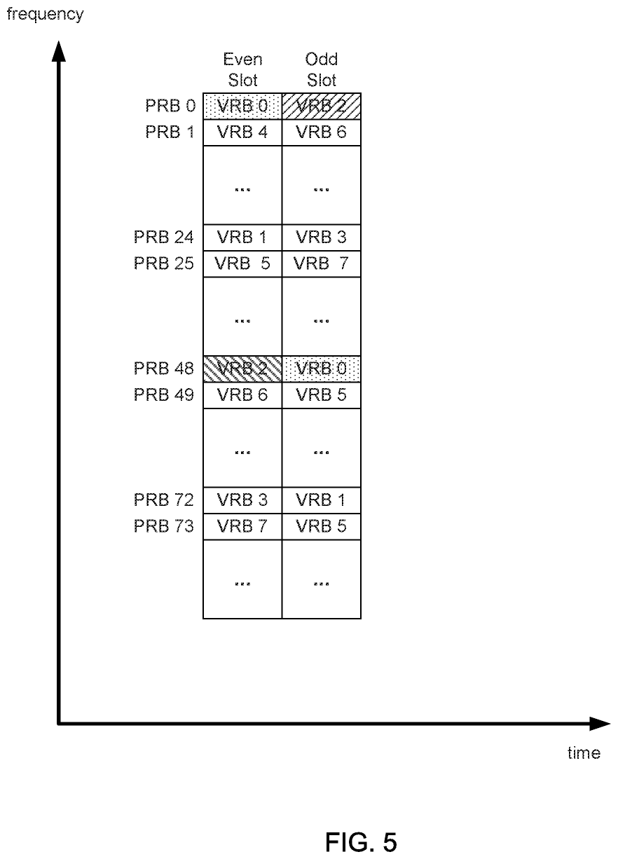

In another example, as illustrated in FIG. 5, four VRBs can be configured as a unit to construct full PRBs, and the ePDCCH can reuse the legacy mapping rule within one specific RB. In this example, VRB 0 and VRB 2 can be paired to cover a full PRB i.e. PRB 0, across two slots. In another example, four virtual resource blocks can be allocated to form two complete physical resource blocks.

In another example, the RB allocation for ePDCCH configuration can be indicated in the MIB. In one example, 1 bit can be configured in the MIB. In this example, a ‘0’ can indicate 0 RBs, which can indicate that the UE can receive the legacy PDCCH for SIB-MF, and a ‘1’ can indicate 8 RBs or 16 RBs. In another example, 2 bits can be configured in the MIB. In this example, ‘00’ can indicate 0 RBs, which can indicate that the UE can receive the legacy PDCCH for SIB-MF, ‘01’ can indicate 8 RBs, ‘10’ can indicate 16 RBs, and ‘11’ can indicate 32 RBs.

In another example, the RB allocation for ePDCCH configuration can contain the VRBs or the VRBS with the remaining PRBs. The remaining PRBs can be the PRBs that have not been assigned to VRBs i.e. PRB #96 to PRB #99.

In another example, one bit can be indicated in the MIB for the VRB gap. In this example, a ‘0’ can indicate that N_{gap}=N_{gap,1} e.g., 48 for a 20 MHz system, and a ‘1’ can indicate that N_{gap}=N_{gap,2} e.g., 16 for a 20 MHz system.

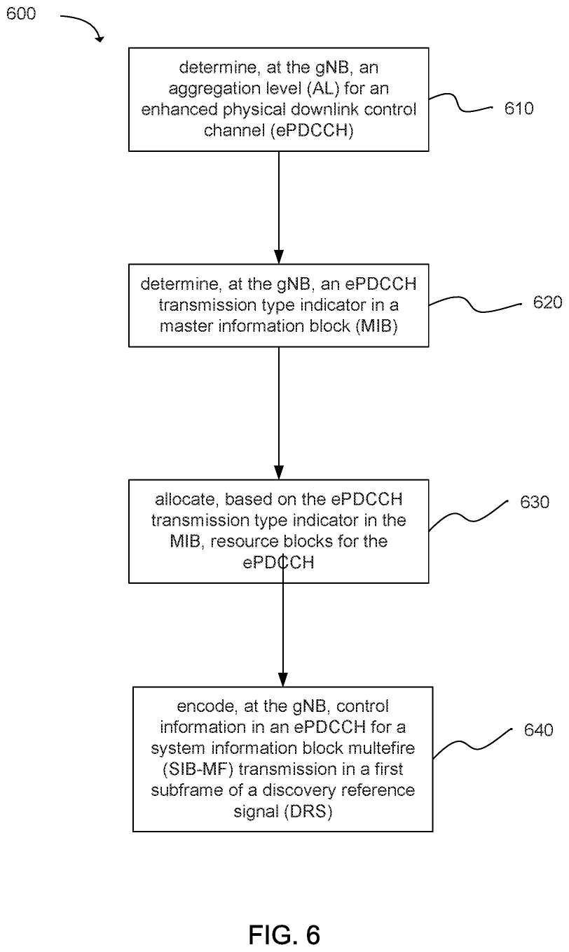

Another example provides functionality 600 of a next generation node B (gNB) operable for wideband coverage enhancement (WCE) communication in a MulteFire cell, as shown in FIG. 6. The gNB can comprise one or more processors. The one or more processors can be configured to determine, at the gNB, an aggregation level (AL) for an enhanced physical downlink control channel (ePDCCH), as in block 610. The one or more processors can be configured to determine, at the gNB, an ePDCCH transmission type indicator in a master information block (MIB), as in block 620. The one or more processors can be configured to allocate, based on the ePDCCH transmission type indicator in the MIB, resource blocks for the ePDCCH as in block 630. The one or more processors can be configured to encode, at the gNB, control information in an ePDCCH for a system information block MulteFire (SIB-MF) transmission in a first subframe of a discovery reference signal (DRS), as in block 640. In addition, the gNB can comprise a memory interface configured to send to a memory the resource blocks containing the ePDCCH.

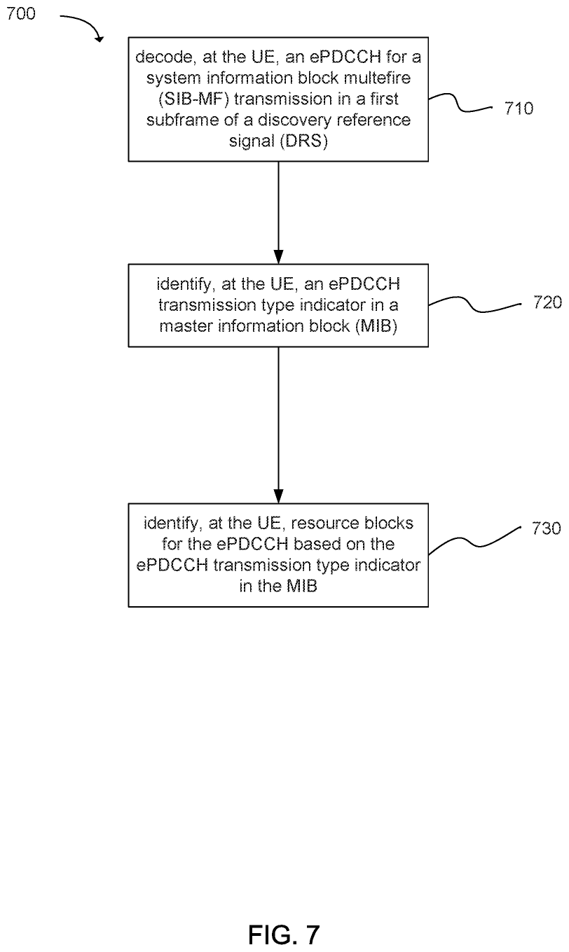

Another example provides functionality 700 of a user equipment (UE) operable for wideband coverage enhancement (WCE) communication in a MulteFire cell, as shown in FIG. 7. The UE can comprise one or more processors. The one or more processors can be configured to decode, at the UE, an ePDCCH for a system information block MulteFire (SIB-MF) transmission in a first subframe of a discovery reference signal (DRS), as in block 710. The one or more processors can be configured to identify, at the UE, an ePDCCH transmission type indicator in a master information block (MIB), as in block 720. The one or more processors can be configured to identify, at the UE, resource blocks for the ePDCCH based on the ePDCCH transmission type indicator in the MIB, as in block 730. In addition, the UE can comprise a memory interface configured to send to a memory the selected resource blocks containing the ePDCCH.

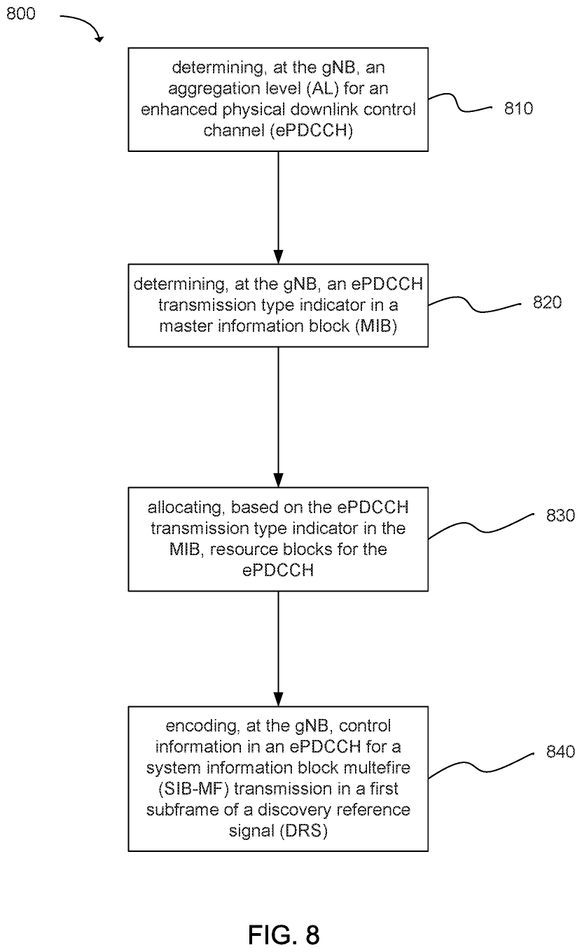

Another example provides at least one machine readable storage medium having instructions 800 embodied thereon for performing wideband coverage enhancement (WCE) communication in a MulteFire cell, as shown in FIG. 8. The instructions can be executed on a machine, where the instructions are included on at least one computer readable medium of one non-transitory machine readable storage medium. The instructions, when executed perform: determining, at the gNB, an aggregation level (AL) for an enhanced physical downlink control channel (ePDCCH), as in block 810. The instructions, when executed perform: determining, at the gNB, an ePDCCH transmission type indicator in a master information block (MIB), as in block 820. The instructions when executed perform: allocating, based on the ePDCCH transmission type indicator in the MIB, resource blocks for the ePDCCH, as in block 830. The instructions when executed perform encoding, at the gNB, control information in an ePDCCH for a system information block MulteFire (SIB-MF) transmission in a first subframe of a discovery reference signal (DRS), as in block 840.

While examples have been provided in which a gNB has been specified, they are not intended to be limiting. An evolved node B (eNodeB) can be used in place of the gNB. Accordingly, unless otherwise stated, any example herein in which a gNB has been disclosed, can similarly be disclosed with the use of an eNodeB.

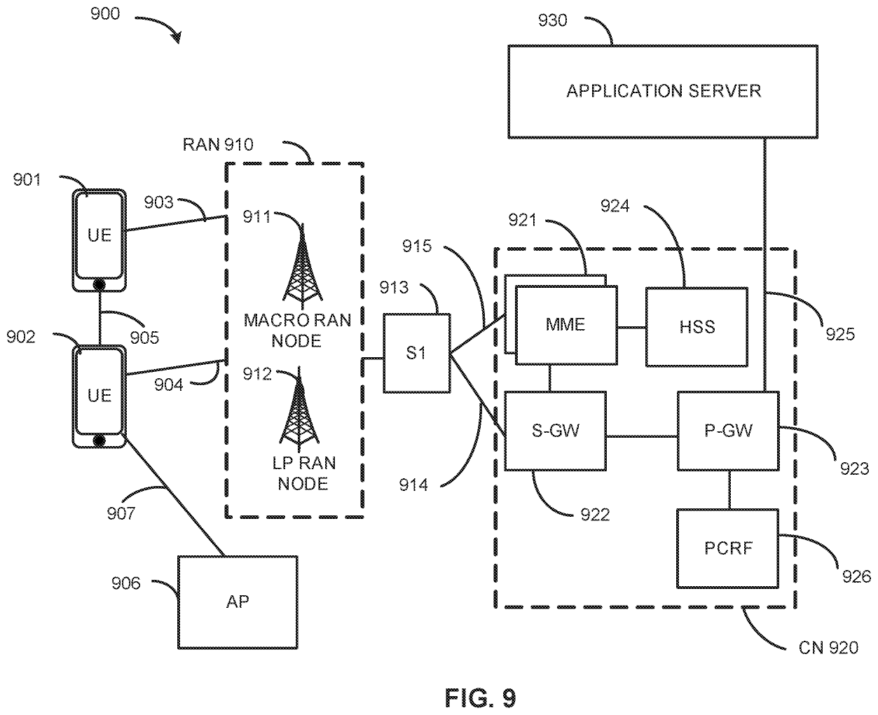

FIG. 9 illustrates an architecture of a system 900 of a network in accordance with some embodiments. The system 900 is shown to include a user equipment (UE) 901 and a UE 902. The UEs 901 and 902 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 901 and 902 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 901 and 902 may be configured to connect, e.g., communicatively couple, with a radio access network (RAN) 910—the RAN 910 may be, for example, an Evolved Universal Mobile Telecommunications System (UMTS) Terrestrial Radio Access Network (E-UTRAN), a NextGen RAN (NG RAN), or some other type of RAN. The UEs 901 and 902 utilize connections 903 and 904, respectively, each of which comprises a physical communications interface or layer (discussed in further detail below); in this example, the connections 903 and 904 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 901 and 902 may further directly exchange communication data via a ProSe interface 905. The ProSe interface 905 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 902 is shown to be configured to access an access point (AP) 906 via connection 907. The connection 907 can comprise a local wireless connection, such as a connection consistent with any IEEE 802.15 protocol, wherein the AP 906 would comprise a wireless fidelity (WiFi®) router. In this example, the AP 906 is shown to be connected to the Internet without connecting to the core network of the wireless system (described in further detail below).

The RAN 910 can include one or more access nodes that enable the connections 903 and 904. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 910 may include one or more RAN nodes for providing macrocells, e.g., macro RAN node 911, and one or more RAN nodes for providing femtocells or picocells (e.g., cells having smaller coverage areas, smaller user capacity, or higher bandwidth compared to macrocells), e.g., low power (LP) RAN node 912.

Any of the RAN nodes 911 and 912 can terminate the air interface protocol and can be the first point of contact for the UEs 901 and 902. In some embodiments, any of the RAN nodes 911 and 912 can fulfill various logical functions for the RAN 910 including, but not limited to, radio network controller (RNC) functions such as radio bearer management, uplink and downlink dynamic radio resource management and data packet scheduling, and mobility management.

In accordance with some embodiments, the UEs 901 and 902 can be configured to communicate using Orthogonal Frequency-Division Multiplexing (OFDM) communication signals with each other or with any of the RAN nodes 911 and 912 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 911 and 912 to the UEs 901 and 902, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 901 and 902. The physical downlink control channel (PDCCH) may carry information about the transport format and resource allocations related to the PDSCH channel, among other things. It may also inform the UEs 901 and 902 about the transport format, resource allocation, and H-ARQ (Hybrid Automatic Repeat Request) information related to the uplink shared channel. Typically, downlink scheduling (assigning control and shared channel resource blocks to the UE 902 within a cell) may be performed at any of the RAN nodes 911 and 912 based on channel quality information fed back from any of the UEs 901 and 902. The downlink resource assignment information may be sent on the PDCCH used for (e.g., assigned to) each of the UEs 901 and 902.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 910 is shown to be communicatively coupled to a core network (CN) 920—via an S1 interface 913. In embodiments, the CN 920 may be an evolved packet core (EPC) network, a NextGen Packet Core (NPC) network, or some other type of CN. In this embodiment the S1 interface 913 is split into two parts: the S1-U interface 914, which carries traffic data between the RAN nodes 911 and 912 and the serving gateway (S-GW) 922, and the S1-mobility management entity (MME) interface 915, which is a signaling interface between the RAN nodes 911 and 912 and MMEs 921.

In this embodiment, the CN 920 comprises the MMEs 921, the S-GW 922, the Packet Data Network (PDN) Gateway (P-GW) 923, and a home subscriber server (HSS) 924. The MMEs 921 may be similar in function to the control plane of legacy Serving General Packet Radio Service (GPRS) Support Nodes (SGSN). The MMEs 921 may manage mobility aspects in access such as gateway selection and tracking area list management. The HSS 924 may comprise a database for network users, including subscription-related information to support the network entities' handling of communication sessions. The CN 920 may comprise one or several HSSs 924, depending on the number of mobile subscribers, on the capacity of the equipment, on the organization of the network, etc. For example, the HSS 924 can provide support for routing/roaming, authentication, authorization, naming/addressing resolution, location dependencies, etc.

The S-GW 922 may terminate the S1 interface 913 towards the RAN 910, and routes data packets between the RAN 910 and the CN 920. In addition, the S-GW 922 may be a local mobility anchor point for inter-RAN node handovers and also may provide an anchor for inter-3GPP mobility. Other responsibilities may include lawful intercept, charging, and some policy enforcement.

The P-GW 923 may terminate an SGi interface toward a PDN. The P-GW 923 may route data packets between the EPC network 923 and external networks such as a network including the application server 930 (alternatively referred to as application function (AF)) via an Internet Protocol (IP) interface 925. Generally, the application server 930 may be an element offering applications that use IP bearer resources with the core network (e.g., UMTS Packet Services (PS) domain, LTE PS data services, etc.). In this embodiment, the P-GW 923 is shown to be communicatively coupled to an application server 930 via an IP communications interface 925. The application server 930 can also be configured to support one or more communication services (e.g., Voice-over-Internet Protocol (VoIP) sessions, PTT sessions, group communication sessions, social networking services, etc.) for the UEs 901 and 902 via the CN 920.

The P-GW 923 may further be a node for policy enforcement and charging data collection. Policy and Charging Enforcement Function (PCRF) 926 is the policy and charging control element of the CN 920. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 926 may be communicatively coupled to the application server 930 via the P-GW 923. The application server 930 may signal the PCRF 926 to indicate a new service flow and select the appropriate Quality of Service (QoS) and charging parameters. The PCRF 926 may provision this rule into a Policy and Charging Enforcement Function (PCEF) (not shown) with the appropriate traffic flow template (TFT) and QoS class of identifier (QCI), which commences the QoS and charging as specified by the application server 930.

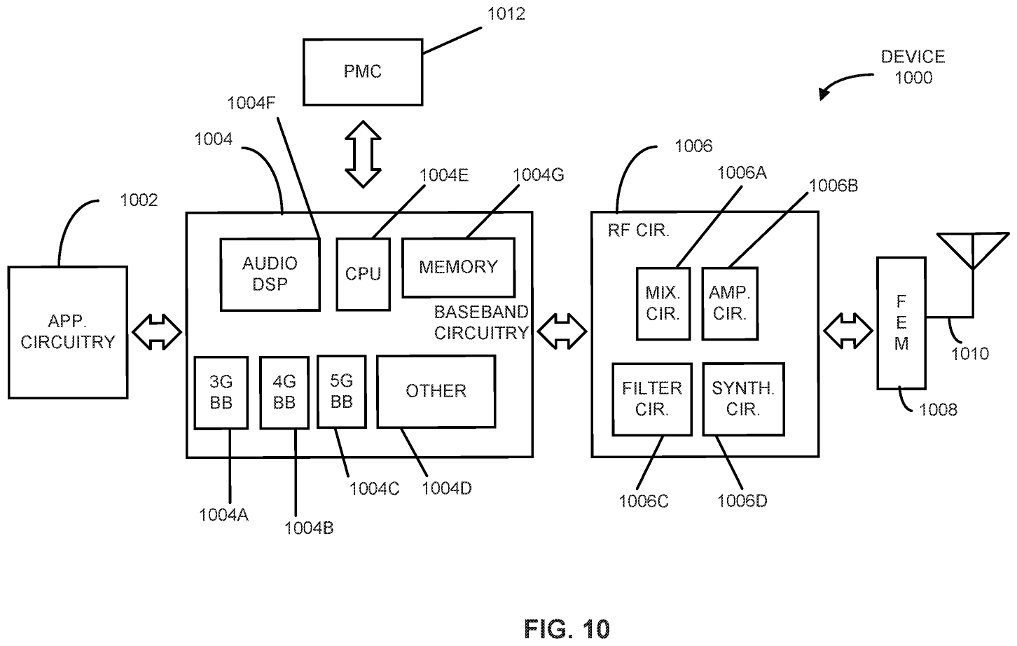

FIG. 10 illustrates example components of a device 1000 in accordance with some embodiments. In some embodiments, the device 1000 may include application circuitry 1002, baseband circuitry 1004, Radio Frequency (RF) circuitry 1006, front-end module (FEM) circuitry 1008, one or more antennas 1010, and power management circuitry (PMC) 1012 coupled together at least as shown. The components of the illustrated device 1000 may be included in a UE or a RAN node. In some embodiments, the device 1000 may include less elements (e.g., a RAN node may not utilize application circuitry 1002, and instead include a processor/controller to process IP data received from an EPC). In some embodiments, the device 1000 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1002 may include one or more application processors. For example, the application circuitry 1002 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1000. In some embodiments, processors of application circuitry 1002 may process IP data packets received from an EPC.

The baseband circuitry 1004 may include circuitry such as, but not limited to, one or more single-core or multi-core processors. The baseband circuitry 1004 may include one or more baseband processors or control logic to process baseband signals received from a receive signal path of the RF circuitry 1006 and to generate baseband signals for a transmit signal path of the RF circuitry 1006. Baseband processing circuitry 1004 may interface with the application circuitry 1002 for generation and processing of the baseband signals and for controlling operations of the RF circuitry 1006. For example, in some embodiments, the baseband circuitry 1004 may include a third generation (3G) baseband processor 1004a, a fourth generation (4G) baseband processor 1004b, a fifth generation (5G) baseband processor 1004c, or other baseband processor(s) 1004d for other existing generations, generations in development or to be developed in the future (e.g., second generation (2G), sixth generation (6G), etc.). The baseband circuitry 1004 (e.g., one or more of baseband processors 1004a-d) may handle various radio control functions that enable communication with one or more radio networks via the RF circuitry 1006. In other embodiments, some or all of the functionality of baseband processors 1004a-d may be included in modules stored in the memory 1004g and executed via a Central Processing Unit (CPU) 1004e. The radio control functions may include, but are not limited to, signal modulation/demodulation, encoding/decoding, radio frequency shifting, etc. In some embodiments, modulation/demodulation circuitry of the baseband circuitry 1004 may include Fast-Fourier Transform (FFT), precoding, or constellation mapping/demapping functionality. In some embodiments, encoding/decoding circuitry of the baseband circuitry 1004 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1004 may include one or more audio digital signal processor(s) (DSP) 1004f. The audio DSP(s) 1004f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1004 and the application circuitry 1002 may be implemented together such as, for example, on a system on a chip (SOC).

In some embodiments, the baseband circuitry 1004 may provide for communication compatible with one or more radio technologies. For example, in some embodiments, the baseband circuitry 1004 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 1004 is configured to support radio communications of more than one wireless protocol may be referred to as multi-mode baseband circuitry.

RF circuitry 1006 may enable communication with wireless networks using modulated electromagnetic radiation through a non-solid medium. In various embodiments, the RF circuitry 1006 may include switches, filters, amplifiers, etc. to facilitate the communication with the wireless network. RF circuitry 1006 may include a receive signal path which may include circuitry to down-convert RF signals received from the FEM circuitry 1008 and provide baseband signals to the baseband circuitry 1004. RF circuitry 1006 may also include a transmit signal path which may include circuitry to up-convert baseband signals provided by the baseband circuitry 1004 and provide RF output signals to the FEM circuitry 1008 for transmission.

In some embodiments, the receive signal path of the RF circuitry 1006 may include mixer circuitry 1006a, amplifier circuitry 1006b and filter circuitry 1006c. In some embodiments, the transmit signal path of the RF circuitry 1006 may include filter circuitry 1006c and mixer circuitry 1006a. RF circuitry 1006 may also include synthesizer circuitry 1006d for synthesizing a frequency for use by the mixer circuitry 1006a of the receive signal path and the transmit signal path. In some embodiments, the mixer circuitry 1006a of the receive signal path may be configured to down-convert RF signals received from the FEM circuitry 1008 based on the synthesized frequency provided by synthesizer circuitry 1006d. The amplifier circuitry 1006b may be configured to amplify the down-converted signals and the filter circuitry 1006c may be a low-pass filter (LPF) or band-pass filter (BPF) configured to remove unwanted signals from the down-converted signals to generate output baseband signals. Output baseband signals may be provided to the baseband circuitry 1004 for further processing. In some embodiments, the output baseband signals may be zero-frequency baseband signals, although this is not a necessity. In some embodiments, mixer circuitry 1006a of the receive signal path may comprise passive mixers, although the scope of the embodiments is not limited in this respect.

In some embodiments, the mixer circuitry 1006a of the transmit signal path may be configured to up-convert input baseband signals based on the synthesized frequency provided by the synthesizer circuitry 1006d to generate RF output signals for the FEM circuitry 1008. The baseband signals may be provided by the baseband circuitry 1004 and may be filtered by filter circuitry 1006c.

In some embodiments, the mixer circuitry 1006a of the receive signal path and the mixer circuitry 1006a of the transmit signal path may include two or more mixers and may be arranged for quadrature downconversion and upconversion, respectively. In some embodiments, the mixer circuitry 1006a of the receive signal path and the mixer circuitry 1006a of the transmit signal path may include two or more mixers and may be arranged for image rejection (e.g., Hartley image rejection). In some embodiments, the mixer circuitry 1006a of the receive signal path and the mixer circuitry 1006a may be arranged for direct downconversion and direct upconversion, respectively. In some embodiments, the mixer circuitry 1006a of the receive signal path and the mixer circuitry 1006a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1006 may include analog-to-digital converter (ADC) and digital-to-analog converter (DAC) circuitry and the baseband circuitry 1004 may include a digital baseband interface to communicate with the RF circuitry 1006.

In some dual-mode embodiments, a separate radio IC circuitry may be provided for processing signals for each spectrum, although the scope of the embodiments is not limited in this respect.

In some embodiments, the synthesizer circuitry 1006d may be a fractional-N synthesizer or a fractional N/N+1 synthesizer, although the scope of the embodiments is not limited in this respect as other types of frequency synthesizers may be suitable. For example, synthesizer circuitry 1006d may be a delta-sigma synthesizer, a frequency multiplier, or a synthesizer comprising a phase-locked loop with a frequency divider.

The synthesizer circuitry 1006d may be configured to synthesize an output frequency for use by the mixer circuitry 1006a of the RF circuitry 1006 based on a frequency input and a divider control input. In some embodiments, the synthesizer circuitry 1006d may be a fractional N/N+1 synthesizer.

In some embodiments, frequency input may be provided by a voltage controlled oscillator (VCO), although that is not a necessity. Divider control input may be provided by either the baseband circuitry 1004 or the applications processor 1002 depending on the desired output frequency. In some embodiments, a divider control input (e.g., N) may be determined from a look-up table based on a channel indicated by the applications processor 1002.

Synthesizer circuitry 1006d of the RF circuitry 1006 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1006d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1006 may include an IQ/polar converter.

FEM circuitry 1008 may include a receive signal path which may include circuitry configured to operate on RF signals received from one or more antennas 1010, amplify the received signals and provide the amplified versions of the received signals to the RF circuitry 1006 for further processing. FEM circuitry 1008 may also include a transmit signal path which may include circuitry configured to amplify signals for transmission provided by the RF circuitry 1006 for transmission by one or more of the one or more antennas 1010. In various embodiments, the amplification through the transmit or receive signal paths may be done solely in the RF circuitry 1006, solely in the FEM 1008, or in both the RF circuitry 1006 and the FEM 1008.

In some embodiments, the FEM circuitry 1008 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 1006). The transmit signal path of the FEM circuitry 1008 may include a power amplifier (PA) to amplify input RF signals (e.g., provided by RF circuitry 1006), and one or more filters to generate RF signals for subsequent transmission (e.g., by one or more of the one or more antennas 1010).

In some embodiments, the PMC 1012 may manage power provided to the baseband circuitry 1004. In particular, the PMC 1012 may control power-source selection, voltage scaling, battery charging, or DC-to-DC conversion. The PMC 1012 may often be included when the device 1000 is capable of being powered by a battery, for example, when the device is included in a UE. The PMC 1012 may increase the power conversion efficiency while providing desirable implementation size and heat dissipation characteristics.

While FIG. 10 shows the PMC 1012 coupled only with the baseband circuitry 1004. However, in other embodiments, the PMC 1012 may be additionally or alternatively coupled with, and perform similar power management operations for, other components such as, but not limited to, application circuitry 1002, RF circuitry 1006, or FEM 1008.

In some embodiments, the PMC 1012 may control, or otherwise be part of, various power saving mechanisms of the device 1000. For example, if the device 1000 is in an RRC_Connected state, where it is still connected to the RAN node as it expects to receive traffic shortly, then it may enter a state known as Discontinuous Reception Mode (DRX) after a period of inactivity. During this state, the device 1000 may power down for brief intervals of time and thus save power.

If there is no data traffic activity for an extended period of time, then the device 1000 may transition off to an RRC_Idle state, where it disconnects from the network and does not perform operations such as channel quality feedback, handover, etc. The device 1000 goes into a very low power state and it performs paging where again it periodically wakes up to listen to the network and then powers down again. The device 1000 may not receive data in this state, in order to receive data, it can transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1002 and processors of the baseband circuitry 1004 may be used to execute elements of one or more instances of a protocol stack. For example, processors of the baseband circuitry 1004, alone or in combination, may be used execute Layer 3, Layer 2, or Layer 1 functionality, while processors of the application circuitry 1004 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

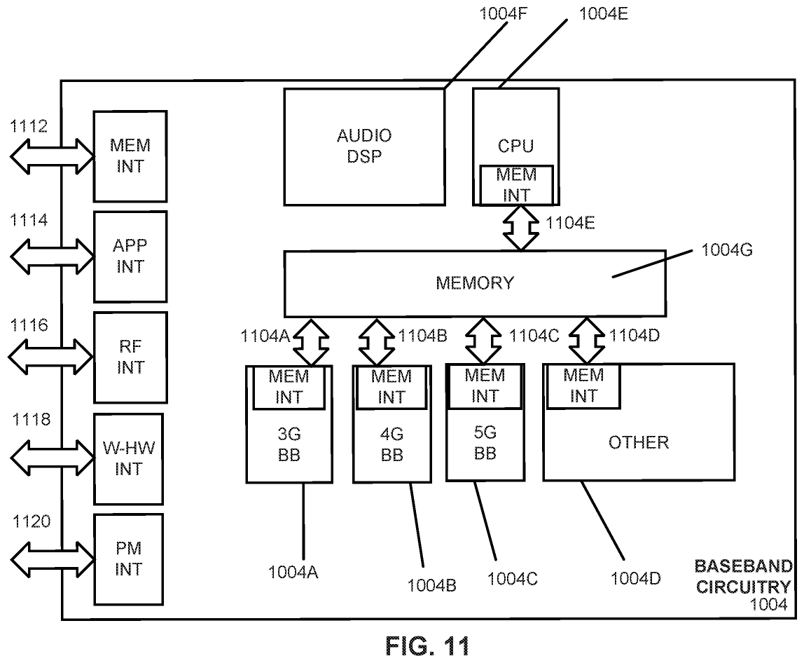

FIG. 11 illustrates example interfaces of baseband circuitry in accordance with some embodiments. As discussed above, the baseband circuitry 1004 of FIG. 10 may comprise processors 1004a-1004e and a memory 1004g utilized by said processors. Each of the processors 1004a-1004e may include a memory interface, 1104a-1104e, respectively, to send/receive data to/from the memory 1004g.

The baseband circuitry 1004 may further include one or more interfaces to communicatively couple to other circuitries/devices, such as a memory interface 1112 (e.g., an interface to send/receive data to/from memory external to the baseband circuitry 1004), an application circuitry interface 1114 (e.g., an interface to send/receive data to/from the application circuitry 1002 of FIG. 10), an RF circuitry interface 1116 (e.g., an interface to send/receive data to/from RF circuitry 1006 of FIG. 10), a wireless hardware connectivity interface 1118 (e.g., an interface to send/receive data to/from Near Field Communication (NFC) components, Bluetooth® components (e.g., Bluetooth® Low Energy), Wi-Fi® components, and other communication components), and a power management interface 1120 (e.g., an interface to send/receive power or control signals to/from the PMC 1012.

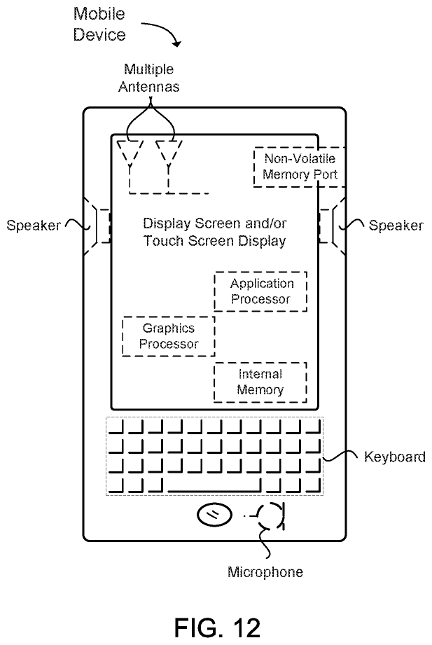

FIG. 12 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband processing unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard such as, but not limited to, 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN. The wireless device can also comprise a wireless modem. The wireless modem can comprise, for example, a wireless radio transceiver and baseband circuitry (e.g., a baseband processor). The wireless modem can, in one example, modulate signals that the wireless device transmits via the one or more antennas and demodulate signals that the wireless device receives via the one or more antennas.

FIG. 12 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be integrated with the wireless device or wirelessly connected to the wireless device to provide additional user input. A virtual keyboard can also be provided using the touch screen.

### EXAMPLES

The following examples pertain to specific technology embodiments and point out specific features, elements, or actions that can be used or otherwise combined in achieving such embodiments.

Example 1 includes an apparatus of a next generation node B (gNB) operable for wideband coverage enhancement (WCE) communication in a MulteFire cell, the apparatus comprising: one or more processors configured to: determine, at the gNB, an aggregation level (AL) for an enhanced physical downlink control channel (ePDCCH); determine, at the gNB, an ePDCCH transmission type indicator in a master information block (MIB); allocate, based on the ePDCCH transmission type indicator in the MIB, resource blocks for the ePDCCH; encode, at the gNB, control information in an ePDCCH for a system information block MulteFire (SIB-MF) transmission in a first subframe of a discovery reference signal (DRS); and a memory interface configured to send to a memory the resource blocks containing the ePDCCH.

Example 2 includes the apparatus of the gNB of Example 1, further comprising one or more processors configured to: allocate, based on the ePDCCH transmission type in the MIB, resource blocks for the ePDCCH, wherein the resource blocks for the ePDCCH are contiguous.

Example 3 includes the apparatus of the gNB of Example 2, further comprising one or more processors configured to: allocate the contiguous resource blocks for the ePDCCH to be utilized by downlink control information (DCI) format 1A.

Example 4 includes the apparatus of the gNB of Example 1, further comprising one or more processors configured to: allocate, based on the ePDCCH transmission type in the MIB, resource blocks for the ePDCCH, wherein the resource blocks for the ePDCCH are distributed.

Example 5 includes the apparatus of the gNB of Example 1, further comprising one or more processors configured to: scramble a demodulation reference signal (DM-RS) for the ePDCCH using a scrambling sequence for the first subframe of the DRS.

Example 6 includes the apparatus of the gNB of Example 1, further comprising one or more processors configured to: allocate, based on the ePDCCH transmission type in the MIB, resource blocks for the ePDCCH, wherein a first set of the resource blocks for the ePDCCH are virtual distributed resource blocks and a second set of the resource blocks for the ePDCCH are virtual distributed resource blocks or remaining contiguous resource blocks.

Example 7 includes the apparatus of Example 6, wherein the first set of the resource blocks for the ePDCCH further comprises eight virtual distributed resource blocks.

Example 8 includes the apparatus of Example 6, wherein the second set of the resource blocks for the ePDCCH further comprises four virtual distributed resource blocks and four remaining contiguous resource blocks.

Example 9 includes the apparatus of the gNB of any of Examples 1 to 6, further comprising one or more processors configured to: allocate, based on the ePDCCH transmission type in the MIB, resource blocks for the ePDCCH, wherein the resource blocks for the ePDCCH comprises sixteen contiguous resource blocks starting from a maximum physical resource block (PRB) index value.

Example 10 includes the apparatus of the gNB of any of Examples 1 to 6, further comprising one or more processors configured to: determine, at the gNB, an aggregation level (AL) for an enhanced physical downlink control channel (ePDCCH), wherein the AL is 32 or 64.

Example 11 includes the apparatus of the gNB of any of Examples 1 to 6, further comprising one or more processors configured to: allocate, at the gNB, four virtual resource blocks to form two complete physical resource blocks.

Example 12 includes an apparatus of a user equipment (UE) operable for wideband coverage enhancement (WCE) communication in a MulteFire cell, the apparatus comprising: one or more processors configured to: decode, at the UE, an ePDCCH for a system information block MulteFire (SIB-MF) transmission in a first subframe of a discovery reference signal (DRS); identify, at the UE, an ePDCCH transmission type indicator in a master information block (MIB); and identify, at the UE, resource blocks for the ePDCCH based on the ePDCCH transmission type indicator in the MIB; and a memory interface configured to send to a memory the resource blocks containing the ePDCCH.

Example 13 includes the apparatus of the UE of Example 12, further comprising one or more processors configured to: identify, based on the ePDCCH transmission type in the MIB, resource blocks for the ePDCCH, wherein a first set of the resource blocks for the ePDCCH are virtual distributed resource blocks and a second set of the resource blocks for the ePDCCH are virtual distributed resource blocks or remaining contiguous resource blocks.

Example 14 includes the apparatus of the UE of Example 13, wherein the first set of the resource blocks for the ePDCCH further comprises eight virtual distributed resource blocks.

Example 15 includes the apparatus of the UE of Example 13, wherein the second set of the resource blocks for the ePDCCH further comprises four virtual distributed resource blocks and four remaining contiguous resource blocks.

Example 16 includes at least one machine readable storage medium having instructions embodied thereon for performing wideband coverage enhancement (WCE) communication in a MulteFire cell, the instructions when executed by one or more processors at a gNB perform the following: determining, at the gNB, an aggregation level (AL) for an enhanced physical downlink control channel (ePDCCH); determining, at the gNB, an ePDCCH transmission type indicator in a master information block (MIB); allocating, based on the ePDCCH transmission type indicator in the MIB, resource blocks for the ePDCCH; and encoding, at the gNB, control information in an ePDCCH for a system information block MulteFire (SIB-MF) transmission in a first subframe of a discovery reference signal (DRS).

Example 17 includes the at least one machine readable storage medium of Example 16, further comprising instructions that when executed perform: allocating, based on the ePDCCH transmission type in the MIB, resource blocks for the ePDCCH, wherein the resource blocks for the ePDCCH are contiguous.

Example 18 includes the at least one machine readable storage medium of Example 16, further comprising instructions that when executed perform: allocating the contiguous resource blocks for the ePDCCH to be utilized by downlink control information (DCI) format 1A.

Example 19 includes the at least one machine readable storage medium of any of Examples 16 to 18, further comprising instructions that when executed perform: allocating, based on the ePDCCH transmission type in the MIB, resource blocks for the ePDCCH, wherein the resource blocks for the ePDCCH are distributed.

Example 20 includes the at least one machine readable storage medium of any of Examples 16 to 18, further comprising instructions that when executed perform: allocating, based on the ePDCCH transmission type in the MIB, resource blocks for the ePDCCH, wherein a first set of the resource blocks for the ePDCCH are virtual distributed resource blocks and a second set of the resource blocks for the ePDCCH are virtual distributed resource blocks or remaining contiguous resource blocks.

Various techniques, or certain aspects or portions thereof, may take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). In one example, selected components of the transceiver module can be located in a cloud radio access network (C-RAN). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module may not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology may be referred to herein along with alternatives for the various components thereof. It is understood that such embodiments, examples, and alternatives are not to be construed as defacto equivalents of one another, but are to be considered as separate and autonomous representations of the present technology.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology can be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology. Accordingly, it is not intended that the technology be limited, except as by the claims set forth below.

What is claimed is:

1-20. (canceled)

21. An apparatus of a next generation node B (gNB) operable for wideband coverage enhancement (WCE) communication in a MulteFire cell, the apparatus comprising:
one or more processors configured to:
determine, at the gNB, an aggregation level (AL) for an enhanced physical downlink control channel (ePDCCH);
determine, at the gNB, an ePDCCH transmission type indicator in a master information block (MIB);
allocate, based on the ePDCCH transmission type indicator in the MIB, resource blocks for the ePDCCH;
encode, at the gNB, control information in an ePDCCH for a system information block MulteFire (SIB-MF) transmission in a first subframe of a discovery reference signal (DRS); and
a memory interface configured to send to a memory the resource blocks containing the ePDCCH.

22. The apparatus of the gNB of claim 21, further comprising one or more processors configured to:
allocate, based on the ePDCCH transmission type in the MIB, resource blocks for the ePDCCH, wherein the resource blocks for the ePDCCH are contiguous.

23. The apparatus of the gNB of claim 21, further comprising one or more processors configured to:
allocate the resource blocks for the ePDCCH to be utilized by downlink control information (DCI) format 1A.

24. The apparatus of the gNB of claim 21, further comprising one or more processors configured to:
allocate, based on the ePDCCH transmission type in the MIB, resource blocks for the ePDCCH, wherein the resource blocks for the ePDCCH are distributed.

25. The apparatus of the gNB of claim 21, further comprising one or more processors configured to:
scramble a demodulation reference signal (DM-RS) for the ePDCCH using a scrambling sequence for the first subframe of the DRS.

26. The apparatus of the gNB of claim 21, further comprising one or more processors configured to:
allocate, based on the ePDCCH transmission type in the MIB, resource blocks for the ePDCCH, wherein a first set of the resource blocks for the ePDCCH are virtual distributed resource blocks and a second set of the resource blocks for the ePDCCH are virtual distributed resource blocks or remaining contiguous resource blocks.

27. The apparatus of claim 26, wherein the first set of the resource blocks for the ePDCCH further comprises eight virtual distributed resource blocks.

28. The apparatus of claim 26, wherein the second set of the resource blocks for the ePDCCH further comprises four virtual distributed resource blocks and four remaining contiguous resource blocks.

29. The apparatus of the gNB of claim 21, further comprising one or more processors configured to:
allocate, based on the ePDCCH transmission type in the MIB, resource blocks for the ePDCCH, wherein the resource blocks for the ePDCCH comprises sixteen contiguous resource blocks starting from a maximum physical resource block (PRB) index value.

30. The apparatus of the gNB of claim 21, further comprising one or more processors configured to:
determine, at the gNB, an aggregation level (AL) for an enhanced physical downlink control channel (ePDCCH), wherein the AL is 32 or 64.

31. An apparatus of a user equipment (UE) operable for wideband coverage enhancement (WCE) communication in a MulteFire cell, the apparatus comprising:
one or more processors configured to:
decode, at the UE, an ePDCCH for a system information block MulteFire (SIB-MF) transmission in a first subframe of a discovery reference signal (DRS);
identify, at the UE, an ePDCCH transmission type indicator in a master information block (MIB); and
identify, at the UE, resource blocks for the ePDCCH based on the ePDCCH transmission type indicator in the MIB; and
a memory interface configured to send to a memory the resource blocks containing the ePDCCH.

32. The apparatus of the UE of claim 31, further comprising one or more processors configured to:
identify, based on the ePDCCH transmission type in the MIB, resource blocks for the ePDCCH, wherein a first set of the resource blocks for the ePDCCH are virtual distributed resource blocks and a second set of the resource blocks for the ePDCCH are virtual distributed resource blocks or remaining contiguous resource blocks.

33. The apparatus of the UE of claim 32, wherein the first set of the resource blocks for the ePDCCH further comprises eight virtual distributed resource blocks.

34. The apparatus of the UE of claim 32, wherein the second set of the resource blocks for the ePDCCH further comprises four virtual distributed resource blocks and four remaining contiguous resource blocks.

35. The apparatus of the UE of claim 32, wherein the UE includes an antenna, a touch sensitive display screen, a speaker, a microphone, a graphics processor, an application processor, an internal memory, a non-volatile memory port, or combinations thereof.

36. At least one machine readable storage medium having instructions embodied thereon for performing wideband coverage enhancement (WCE) communication in a MulteFire cell, the instructions when executed by one or more processors at a gNB perform the following:
determining, at the gNB, an aggregation level (AL) for an enhanced physical downlink control channel (ePDCCH);
determining, at the gNB, an ePDCCH transmission type indicator in a master information block (MIB);
allocating, based on the ePDCCH transmission type indicator in the MIB, resource blocks for the ePDCCH; and
encoding, at the gNB, control information in an ePDCCH for a system information block MulteFire (SIB-MF) transmission in a first subframe of a discovery reference signal (DRS).

37. The at least one machine readable storage medium of claim 36, further comprising instructions that when executed perform:
allocating, based on the ePDCCH transmission type in the MIB, resource blocks for the ePDCCH, wherein the resource blocks for the ePDCCH are contiguous.

38. The at least one machine readable storage medium of claim 36, further comprising instructions that when executed perform:
allocating the contiguous resource blocks for the ePDCCH to be utilized by downlink control information (DCI) format 1A.

39. The at least one machine readable storage medium of claim 36, further comprising instructions that when executed perform:
allocating, based on the ePDCCH transmission type in the MIB, resource blocks for the ePDCCH, wherein the resource blocks for the ePDCCH are distributed.

40. The at least one machine readable storage medium of claim 36, further comprising instructions that when executed perform:
allocating, based on the ePDCCH transmission type in the MIB, resource blocks for the ePDCCH, wherein a first set of the resource blocks for the ePDCCH are virtual distributed resource blocks and a second set of the resource blocks for the ePDCCH are virtual distributed resource blocks or remaining contiguous resource blocks.
